(19) United States
(12) Patent Application Publication
(10) Pub. No.: US 2009/0062502 A1
(43) Pub. Date: Mar. 5, 2009

(54) Resin having both aromatic ketone structure and benzoxazine structure

(75) Inventors: Hatsuo Ishida, Shaker Heights, OH (US); Masanori Nakamura, Beachwood, OH (US)

Correspondence Address: SUGHRUE MION, PLLC, 2100 PENNSYLVANIA AVENUE, N.W., SUITE 800, WASHINGTON, DC, 20037, US

(73) Assignee: Sekisui Chemical Co., Ltd., Osaka-shi (JP)

(21) Appl. No.: 11/892,714

(22) Filed: Aug. 27, 2007

(51) Int. Cl. C08G 12/26

(52) U.S. Cl. 528/229

(57) ABSTRACT

The present invention provides a resin having both an aromatic ketone structure and a benzoxazine structure, having a repeat unit represented by following general formula (1)

—[B—C(═O)—B-A]ₙ- formula (1):

(wherein A represents a directly coupling single bond or a diamine residue, B represents a group that contains a benzoxazine structure and is bonded by an aromatic part of the benzoxazine structure to the —C(═O)—, and n represents an Integer in a range of from 3 to 30).

### BACKGROUND

The present invention relates to a resin, having both an aromatic ketone structure and a benzoxazine structure, and more specifically relates to a resin, having both an aromatic ketone structure and a benzoxazine structure. The resin has high solvent solubility, can be made into a film by casting, and has excellent heat resistance and mechanical strength.

Polyketone resins are widely used as materials for electrochemical elements and the like. For example, in Japanese Patent Application Laid-open No. 2005-272728, with an object of providing an aromatic polyketone that has excellent heat resistance, is easily processed and has excellent flexibility, and is suitable as a material for electrochemical elements, there is proposed an aromatic polyketone having a specified repeat unit.

However, dissolving such an aromatic polyketone resin in a solvent is generally difficult, and the processability, such as the ability to make into a film and the heat resistance is poor.

Moreover, in “Dynamic mechanical and thermal characterization of high performance polybenzoxazine”, J. Polymer Science Part B, Vol. 37(1999), a research example of a compound having both an aromatic ketone structure and a benzoxazine structure is disclosed, but this compound has too small a molecular weight for obtaining a cast film, and moreover the cured material obtained is brittle.

### SUMMARY

It is thus an object of the present invention to provide a resin having both an aromatic ketone structure and a benzoxazine structure that has improved solubility, can be made into a film by casting, and has very high heat resistance. Moreover, the benzene ring in the benzoxazine structure may have substituents thereon, or may have a fused ring thereon.

The present inventors carried out assiduous studies to attain the above object, and as a result accomplished the present invention upon discovering that, compared with an aromatic polyketone resin that is generally not readily soluble in a solvent, the above object can be attained by a resin having both an aromatic ketone structure and benzoxazine structure.

That is, the present invention is as follows.

A resin having both an aromatic ketone structure and a benzoxazine structure obtained through the present Invention has excellent solvent solubility, and hence can easily be dissolved in any of various solvents when molding. Moreover, the resin having both an aromatic ketone structure and a benzoxazine structure of the present invention can be made into a film by casting. Moreover, a molded article obtained by heating and molding the resin having both an aromatic ketone structure and a benzoxazine structure of the present invention has excellent heat resistance and mechanical strength, and hence can be suitably used for an electrical/electronic component, an automobile component, a copper-clad laminated board, a printed board, a heat-resistant adhesive or the like.

### DESCRIPTION OF THE DRAWINGS

FIG. 1 shows an infrared absorption spectrum of a resin having both an aromatic ketone structure and a benzoxazine structure of Example 1; and

FIG. 2 shows a nuclear magnetic resonance spectrum of the resin having both an aromatic ketone structure and a benzoxazine structure of Example 1.

### DESCRIPTION OF THE PREFERRED EMBODIMENTS

A resin having both an aromatic ketone structure and a benzoxazine structure of the present invention is a novel resin having a repeat unit represented by general formula (1), being a thermosetting resin that has high solvent solubility, can be made into a film by casting, and has excellent heat resistance and mechanical strength. The resin having both an aromatic ketone structure and a benzoxazine structure of the present invention is characterized by containing an aromatic ketone structure and a benzoxazine structure in the repeat unit.

—[B—C(═O)—B-A]ₙ- formula (1):

(In the formula, A represents a directly coupling single bond or a diamine residue, B represents a group that contains a benzoxazine structure and is bonded by an aromatic part of the benzoxazine ring structure to the —C(═O)—, and n represents an integer in a range of from 3 to 30.)

Examples of the structure of B, and examples of the structure of —[B—C(═O)—B-A]ₙ- are shown below.

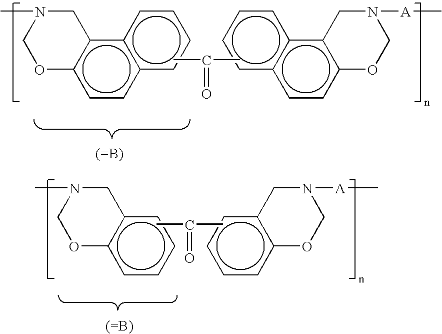

In above general formula (1), A represents a directly coupling single bond or a diamine residue; there are no particular limitations on a diamine residue represented by A, but a preferable example is a group originating from a diamine such as 4,4′-diaminodiphenyl ether, 4,4′-(p-biphenylenedioxy)dianiline, p-phenylenediamine, or 4,4′-diaminodiphenylmethane.

Moreover, in the above general formula (1), there are no particular limitations on the aromatic part of the benzoxazine structure contained in B which represents a group that contains a benzoxazine structure and is bonded by the aromatic part forming part of the benzoxazine structure to the —C(═O)—, but preferable examples include a benzene ring, a naphthalene ring, aromatic polyethers, and aromatic polyketones.

Moreover, in above general formula (1), n represents the average repeat number for the polymer, being an integer in a range of from 3 to 30, preferably from 5 to 20. If n is less than 3, then the heat resistance and the mechanical strength tend to be poor, whereas if n exceeds 30, then the solvent solubility tends to be poor.

Method of Manufacturing Resin having Both an Aromatic Ketone Structure and a Benzoxazine Structure

The resin having both an aromatic ketone structure and a benzoxazine structure of the present invention may be manufactured using any method, for example may be obtained by using an aromatic ketone having two hydroxy groups and an aldehyde compound, heating and dissolving in a suitable solvent such as DMSO, and then adding a diamine.

There are no particular limitations on the aldehyde compound; for example, formaldehyde, acetaldehyde, propionaldehyde, or butyl aldehyde may be used, with formaldehyde being preferable of these due to having excellent reactivity. The formaldehyde may be used, for example, in the form of paraformaldehyde which is a polymer, or formalin which is an aqueous solution. There are no particular limitations on the amount used of the aldehyde compound, but the aromatic ketone unit/aldehyde compound molar ratio is preferably in a range of from 0.05 to 0.25, more preferably from 0.1 to 0.2.

There are no particular limitations on the solvent used; examples include dimethyl sulfoxide (DMSO), N-methylpyrrolidone, dimethyl acetamide, and dimethyl formamide, with DMSO being preferable due to giving excellent reactivity. Moreover, subjecting the solvent to distillation and dehydration treatment before use is preferable so that the reactivity does not drop.

There are no particular limitations on the reaction temperature and the reaction time, but the reaction is generally carried out for from 2 minutes to 1 hour at a temperature of approximately 120 to 200° C. In the present invention, reacting for from 3 to 30 minutes at from 150 to 180° C. is particularly preferable as conditions for suppressing side reactions.

Moreover, after the reaction, a large amount of a poor solvent such as methanol may be added to the solution so as to precipitate out the polymer, which may then be separated out and dried, whereby the desired resin having both an aromatic ketone structure and a benzoxazine structure can be obtained.

The molecular weight of the resin having both an aromatic ketone structure and a benzoxazine structure is preferably in a range of from 2,000 to 40,000, more preferably from 5,000 to 20,000. If the molecular weight is lower than such a range, then the heat resistance and the mechanical strength tend to be poor, whereas if the molecular weight is higher than such a range, then the solvent solubility tends to be poor The molecular weight referred to here is the weight average molecular weight, being the value measured by SEC (size exclusion chromatography).

The resin having both an aromatic ketone structure and a benzoxazine structure of the present Invention forms a strong cured resin (molded article) upon heating due to having the benzoxazine structure in the molecule thereof. For example, the resin having both an aromatic ketone structure and a benzoxazine structure of the present invention is dissolved in a solvent, such as dimethyl formamide or dimethyl acetamide. Then, the solution is applied onto a substrate, the solvent is evaporated off by heating for from 10 minutes to 2 hours at a temperature of from 120 to 180° C., and then curing is carried out by heating for from 10 minutes to 2 hours at a temperature of from 200 to 280° C., whereby a film or sheet can be obtained.

The resin having both an aromatic ketone structure and a benzoxazine structure of the present invention has excellent solubility, and moreover, a molded article obtained by heating and molding can be bestowed with excellent heat resistance and mechanical strength. The resin having both an aromatic ketone structure and a benzoxazine structure of the present invention can thus be easily molded into a film or the like, and the molded article obtained can be suitably used for an electrical/electronic component, an automobile component, a copper-clad laminated board or the like.

### EXAMPLES

The present invention is described in more detail through examples below; however, the present invention is not limited by the examples described below. Note that “%” in the following means “wt %”.

### Measurement Methods

Measurement methods for physical properties and so on in the present specification are as follows.

### (1) Infrared Absorption Spectrum (IR Spectrum)

Bomem Michelson MB100 FT-IR spectrometer
In dry air, 32 scans, KBr pellets used

### (2) Nuclear Magnetic Resonance Spectrum (NMR Spectrum)

¹H NMR (600 MHz) made by Varian Inova
Deuterated dimethyl sulfoxide used, 256 transients, relaxation time 10 seconds

### (3) Thermal Decomposition Resistance

Using a high resolution 2950 thermogravimebic analyzer (made by TA Instruments), the 5% weight reduction temperature (Td5) was measured at a heating rate of 5° C./min.

### (4) Tensile Strength

Instron Universal Tester (Model 5565)
Test piece; Type VASTM D6-38-03
Measurement carried out at crosshead speed of 1 mm/min

### (5) Glass Transition Temperature

Rheometrics RMS-800 dynamic mechanical spectrometer
Strain applied 0.15%, heating rate 1.8° C./min, frequency 1 Hz
Test piece size: 55×12×2 mm
The glass transition temperature was measured at the maximum of the loss modulus curve.

### Example 1

(Manufacture of Resin having Both an Aromatic Ketone Structure and a Benzoxazine Structure)

### Manufacture of Resin Represented by the Following Formula (2)

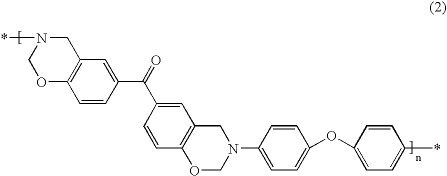

In the following synthesis, dimethyl sulfoxide (hereinafter referred to as “DMSO”) that had been distilled and then subjected to dehydration treatment by adding a molecular sieve (4 A) was used as a solvent.

10 Grams of 4,4-dihydroxybenzophenone (Kennedy & KLIM, Inc.), 8 g of paraformaldehyde (Aldrich Chemical Company Inc.), and 150 g of the DMSO (Aldrich Chemical Company Inc.) were added to a 300 cc round bottom flask, and dissolution was carried out by heating while stirring in an oil bath set to 170° C.

Next, 8 g of 4,4′-diaminodiphenyl ether (Lancaster) was added, and then stirring was continued for 4 minutes or 6 minutes, and then the solution was cooled. The solution was instilled into 300 g of methanol while stirring vigorously. The solid thus precipitated was filtered off, and then washed using methanol.

The powder thus obtained was subjected to vacuum drying for 24 hours in a vacuum oven heated to 60° C. (yield 95 wt %).

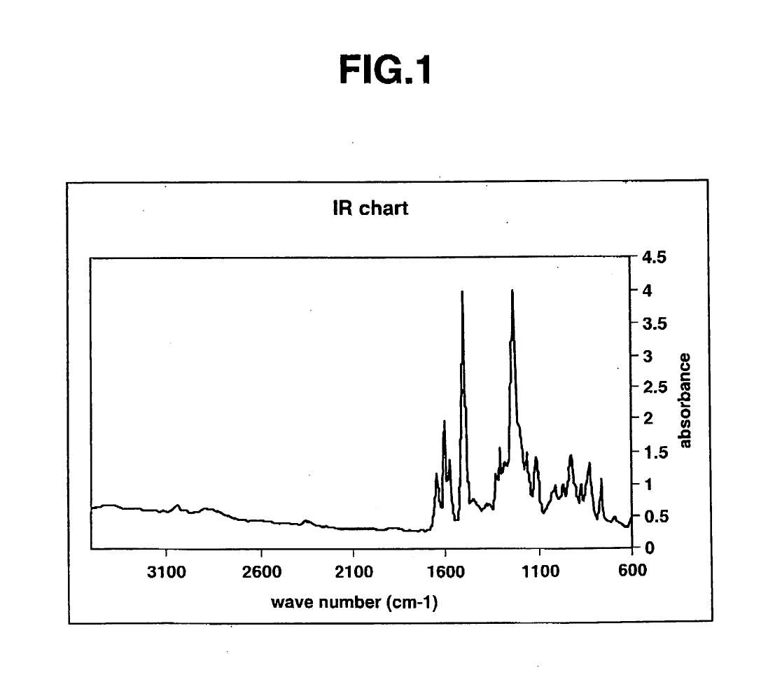

FIG. 1 shows an IR chart for the sample synthesized in Example 1. The characteristic absorption peaks seen are as follows: aromatic ether: 1239 cm⁻¹, oxazine ring-possessing benzene ring: 929 cm⁻¹, carbonyl functional group (benzophenone): 1665 cm⁻¹.

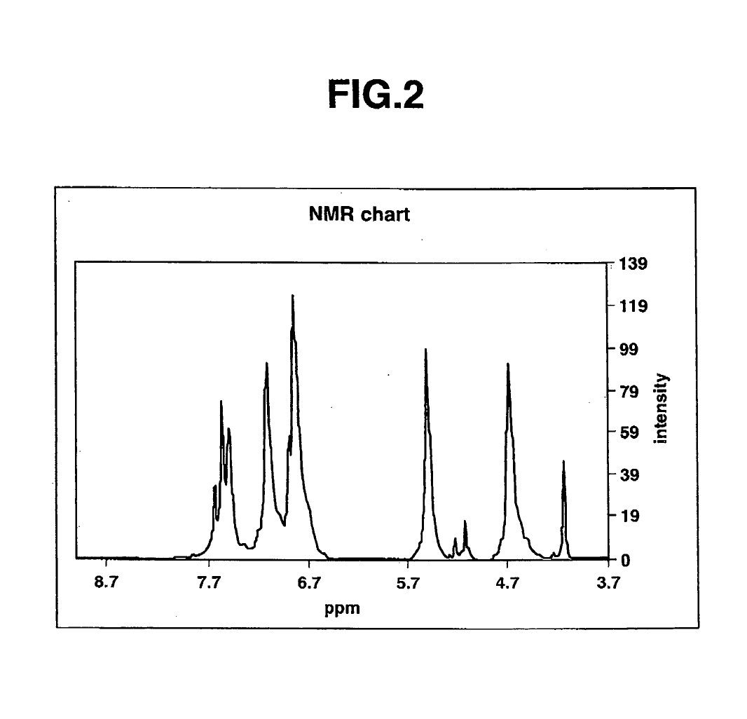

Moreover, FIG. 2 shows an NMR chart for the sample synthesized in Example 1. The two sharp peaks of equal size characteristic of an oxazine ring are seen around 5.5 ppm and 4.7 ppm. These correspond respectively to the hydrogens of —O—CH₂—N— and φ-CH₂—N—.

With heating and stirring for 3 minutes, the IR and NMR peaks corresponding to the existence of an oxazine ring were not observed. This means that the oxazine ring had not formed. Moreover, with heating and stirring for 10 minutes, the IR and NMR peaks corresponding to the existence of an oxazine ring were not observed. This means that the oxazine ring had opened.

### Example 2

### Manufacture of Resin Represented by Following Formula (3)

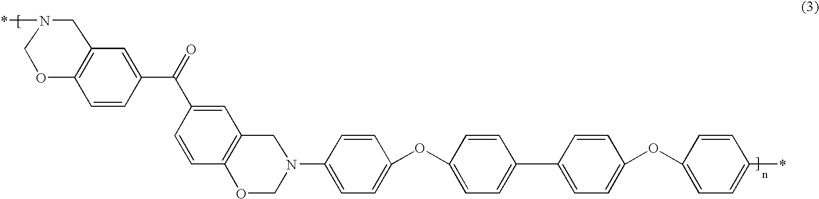

(In the formula, n is defined as before.)

Synthesis of a resin having both an aromatic ketone structure and a benzoxazine structure was carried out using the same procedure as in Example 1, except that instead of the 4,4′-diaminodiphenyl ether, 6.5 g of 4,4′-(p-biphenylenedioxy)dianiline (97%, Wako Pure Chemical Industries, Ltd.) was used (yield 98%).

### Comparative Example 1

### (Synthesis of High Molecular Weight Aromatic Polyketone)

In the following synthesis, N-methylpyrrolidone (hereinafter referred to as “NMP”) that had been distilled and then subjected to dehydration treatment by adding a molecular sieve (4 A) was used as a solvent.

4 g of 4,4′-difluorobenzophenone (Aldrich Chemical Company Inc.), 1.5 g of 4,4-dihydroxybenzophenone (Kennedy & KLIM, Inc.), 3 g of bisphenol A (Aldrich Chemical Company Inc.), and 10 g of the NMP were added to a 300 cc round bottom flask, and dissolution was carried out by heating in an oil bath set to 170° C.

Next, 12 g of potassium carbonate (Aldrich Chemical Company Inc.) was poured into the flask and the mixture was stirred vigorously.

Next, 10 g of toluene was added, and then a Dean-Stark condenser was attached to the flask, and reaction was continued for 5 hours at 170° C. while removing water produced in the synthesis, with most depositing out during the heating.

The reaction products were added into 100 g of methanol while stirring vigorously. The solid thus precipitated was filtered off, and then washed using methanol. The powder thus obtained was subjected to vacuum drying for 24 hours in a vacuum oven heated to 100° C.

### Manufacture of Sheets

The polymer manufactured in each of above Examples 1 and 2 and Comparative Example 1 was dissolved in dimethyl formamide (DMF) (10 w/w%), and the solution was poured into a frame placed on a Teflon substrate. The solvent was removed by evaporation as is in a hot blast oven set to 135° C. (evaporation time: 90 minutes). After that, the set temperature of the oven was changed to 240° C., and curing of the resin was carried out for 1 hour at this temperature. The color of the sheet changed from pale yellow to reddish brown upon ring opening polymerization of the benzoxazine.

For the sample of Comparative Example 1, the solubility in DMF was poor, and hence a sheet was manufactured by hot pressing (temperature 250° C., pressure 5 kg/cm², pressing time 5 minutes, followed by cooling), and evaluation was carried out.

### Performance Evaluation

Using each of the sheets obtained as described above, the thermal decomposition resistance, the tensile strength, and the glass transition temperature

TABLE 1

| | THERMAL | | |
|---|---|---|---|
| | DECOMPOSITION | | GLASS |
| | RESISTANCE | TENSILE | TRANSITION |
| | (Td5) | STRENGTH | TEMPERATURE |
| EXAMPLE 1 | 435° C. | 75 Mpa | 285° C. |
| EXAMPLE 2 | 458° C. | 85 Mpa | 270° C. |
| COMPARATIVE | 478° C. | 65 Mpa | 147° C. |
| EXAMPLE 1 | | | |

As is clear from the above results, the resin having both an aromatic ketone structure and a benzoxazine structure of each of Examples 1 and 2 according to the present invention has excellent solvent solubility despite having a poorly soluble aromatic ketone structure in the molecule thereof, and can be made into a film by casting, it being easy to obtain a heat-resistant film having a high glass transition temperature.

1. A resin having both an aromatic ketone structure and a benzoxazine structure, having a repeat unit represented by the following general formula (1)
—[B—C(═O)—B-A]ₙ- formula (1):
wherein A represents a directly coupling single bond or a diamine residue, B represents a group that contains a benzoxazine structure and is bonded by an aromatic part of the benzoxazine structure to the —C(═O)—, and n represents an integer in a range of from 3 to 30.

2. The resin having both an aromatic ketone structure and a benzoxazine structure according to claim 1, wherein the diamine residue represented by A is a group originating from a diamine selected from the group consisting of 4,4′-diaminodiphenyl ether, 4,4′-(p-biphenylenedioxy)dianiline, p-phenylenediamine, and 4,4′-diaminodiphenylmethane.

3. The resin having both an aromatic ketone structure and a benzoxazine structure according to claim 1, wherein the aromatic part of the benzoxazine structure represented by B is selected from the group consisting of a benzene ring, a naphthalene ring, aromatic polyethers, and aromatic polyketones.
